(19) United States
(12) Patent Application Publication
(10) Pub. No.: US 2008/0105122 A1
(43) Pub. Date: May 8, 2008

(54) Pressure-swing adsorption method and device

(76) Inventors: Paul Leitgeb, Pullach (DE); Jan Oppermann, Munich (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/708,684

(22) Filed: Feb. 21, 2007

(30) Foreign Application Priority Data
Feb. 22, 2006 (DE) 10 2006 008 194.3

(51) Int. Cl. B01D 53/02

(52) U.S. Cl. 95/116; 96/132

(57) ABSTRACT

Fractionation by adsorption of a hydrogen-containing gas mixture can be achieved by passing the gas mixture over an adsorption bed containing an activated-carbon layer a downstream molecular sieve layer of the 5 A type, and positioned between the activated-carbon layer and the downstream molecular sieve layer, an intermediate layer containing molecular sieve of the X type. A hydrogen-rich gas mixture is then removed. The molecular sieve(s) of the X type, can be a CaX type, an NaX type, or combinations thereof.

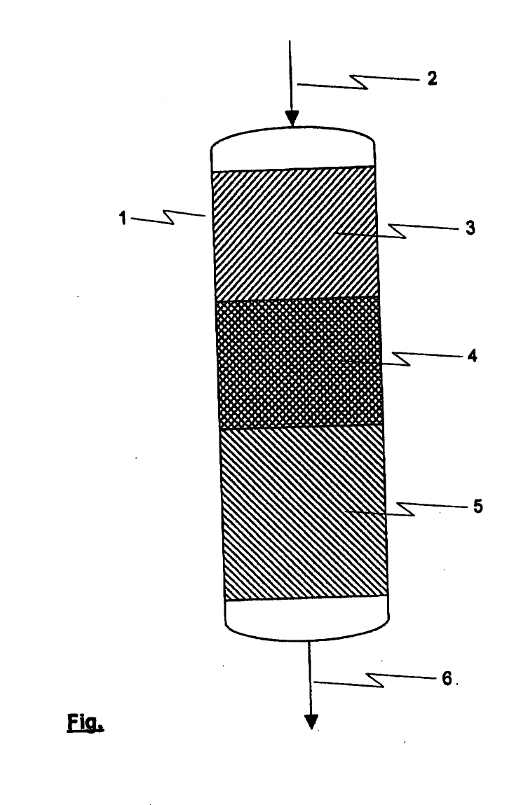

The invention relates to a method for fractionation by adsorption of a hydrogen-containing gas mixture, the gas mixture being passed over an adsorption bed containing an activated-carbon layer and a downstream molecular sieve layer of the 5 A type, and a hydrogen-rich gas mixture being taken off.

In addition, the invention relates to a device for the fractionation by adsorption of a hydrogen-containing gas mixture, containing an activated-carbon layer and a downstream molecular sieve layer of the 5 A type, over which the gas mixture to be fractionated is passed.

By means of pressure-swing adsorption methods, hydrogen can be obtained from differing gas mixtures, for example from steam reformer or refinery gas mixtures. In these cases heavier components are separated off in order to be able to obtain hydrogen as a very pure product gas and in high yield. Components such as N₂, O₂, CO, CH₄ and other hydrocarbons and also CO₂ are removed using adsorption beds which contain activated carbon and molecular sieves as adsorbents in a layered bed. The raw material or hydrogen-containing gas mixture is thus separated by adsorption into two process gas streams, a product gas stream containing hydrogen with small amounts of impurities of N₂, O₂, CO and/or CH₄, and also a residual gas stream having the enriched heavier components.

In the isolation or purification of hydrogen from a steam reformer gas by means of a pressure-swing adsorption process, in the upstream activated-carbon bed, especially the components CO₂ and CH₄ are depleted. The capacity of the activated carbon with respect to these components and also the unwanted coadsorption of hydrogen substantially determine the plant performance of the pressure-swing adsorption process. The optimum activated carbon:molecular sieve ratio in the structure of the entire bed must be determined according to process conditions. Critical factors for a competitive pressure-swing adsorption method are the parameters hydrogen productivity and also hydrogen yield.

Owing to the (co)adsorption of hydrogen on the activated-carbon layer and the high void volume of the activated-carbon layers, significant amounts of hydrogen pass into the residual gas stream. A reduction of this amount of hydrogen would lead to desired increases in hydrogen yield and hydrogen productivity of the pressure-swing adsorption process achieved in each case. Owing to the good desorbability of carbon dioxide in the activated-carbon layer and the improved working loading with respect to CO₂ and CH₄, compared with molecular sieves routinely used for such methods, a substantial fraction of activated carbon in the total bed must be used for an optimum structuring of the pressure-swing adsorption process achieved in each case.

### SUMMARY OF THE INVENTION

An object of the present invention is to provide a method of the general type described above and also a device of the general type described above for the fractionation by adsorption of a hydrogen-containing gas mixture, which method and device avoid the abovementioned disadvantages.

Upon further study of the specification and appended claims, further objects, aspects and advantages of this invention will become apparent to those skilled in the art.

To achieve these objects, a method of the general type and also a device of the general type are proposed for the fractionation by adsorption of a hydrogen-containing gas mixture which is characterized in that, between the activated-carbon layer and the downstream molecular sieve layer, an intermediate layer containing a molecular sieve of the X type is provided.

Further advantageous embodiments of the method according to the invention or of the device according to the invention for the fractionation by adsorption of a hydrogen-containing gas mixture are characterized in that
as molecular sieve(s) of the X type, preferably use is made of a CaX type and/or an NaX type,
the ratio of activated-carbon layer:intermediate layer (X type): molecular sieve layer (5 A type) in volume fractions is preferably 0.1 to 0.5:0.1 to 0.5:0.2 to 0.8, especially 0.3:0.2:0.5 and
if the hydrogen-containing gas mixture to be fractionated contains water, the water is preferably removed in an adsorbent layer upstream of the activated-carbon layer. Suitable materials for use in this adsorbent layer are activated aluminas, silica gels, and molecular sieves.

Surprisingly, it has now been found that by providing an intermediate layer containing a molecular sieve of the X type, a significant improvement of the plant and process performances with respect to capacity and hydrogen yield can be achieved. This applies in particular in the case of use of a molecular sieve of the NaX type as the intermediate layer.

A molecular sieve of the NaX type is distinguished by a good desorption behavior compared with routinely used molecular sieves of 5 A type, in particular with respect to carbon dioxide. Owing to the higher bulk density, this is approximately 700 g/l compared with approximately 400 to 600 g/l for various activated carbon materials, and the associated lower void volume and lower hydrogen adsorption, partial replacement of the activated carbon by a molecular sieve of the X type, in particular of the NaX type, achieves significantly less hydrogen in the residual gas stream. This results in a significant increase of the hydrogen yield and also in productivity of the pressure-swing adsorption process.

This is achieved because the molecular sieve used for the intermediate layer has properties of the activated carbon that is high carbon dioxide working loading, high adsorption loadings for carbon dioxide and methane, and properties of the molecular sieve, that is good mass transfer and high adsorption loadings for carbon dioxide, methane, carbon monoxide and nitrogen.

For the high purification of hydrogen, that is depletion of the components, CO, CH₄ and N₂, a certain fraction of molecular sieve of the 5 A type is required as topmost bed at the adsorber exit. Likewise, for bulk removal of the components carbon dioxide and methane, a certain fraction of activated carbon is required at the adsorber inlet, owing to the higher working loading of activated carbon compared with the molecular sieve.

According to a further apparatus aspect of the invention, the device for fractionation by adsorption of a hydrogen-containing gas mixture, comprises an absorber having an inlet for introducing a hydrogen-containing gas mixture and an outlet for removing a hydrogen-rich gas mixture. Positioned between the inlet and the outlet are an activated-carbon layer, an intermediate layer containing a molecular sieve of the X type, and a downstream molecular sieve layer of the 5 A type. The intermediate layer is positioned between the activated-carbon layer the downstream molecular sieve layer of the 5 A type.

According to a further apparatus aspect of the invention, there is provided a pressure-swing adsorption system which comprises a plurality of adsorbers connected in series, wherein at least one of the adsorber comprises an absorber having an inlet and an outlet, and, positioned between the inlet and the outlet, an activated-carbon layer, an intermediate layer containing a molecular sieve of the X type, and a downstream molecular sieve layer of the 5 A type. The intermediate layer is positioned between the activated-carbon layer the downstream molecular sieve layer of the 5 A type.

When a molecular sieve of the NaX type is used as an intermediate layer, the activated-carbon bed upstream of the intermediate layer, in particular in the case of low carbon dioxide contents and/or at low loading, can be dimensioned to be significantly smaller than is the case in the methods and devices of the general type of the prior art.

### BRIEF DESCRIPTION OF THE DRAWING

Various other features and attendant advantages of the present invention will be more fully appreciated as the same becomes better understood when considered in conjunction with the accompanying drawing wherein the drawing illustrates an adsorber in accordance with the invention.

### DETAILED DESCRIPTION

The FIGURE shows an adsorber 1 having an inlet 2 and an outlet 6. Near the inlet 2 the adsorber has an activated carbon layer 3 and near the outlet the adsorber has a molecular sieve layer 5 of the 5 A type. Between activated carbon layer 3 an molecular sieve layer 5 there is positioned an intermediate layer 4 containing a molecular sieve of the X type. As mentioned above, between the inlet 2 and the activated carbon layer 3 there can be an additional adsorbent layer for the removal of water.

### EXAMPLE

The method of the invention and also the device of the invention for the fractionation by adsorption of a hydrogen-containing gas mixture may be described in more detail with reference to the method example hereinafter.

The method example may be what is termed a 411-H₂-pressure-swing adsorption process in which four active adsorbers and one pressure equilibration step are provided. Such an adsorption process serves, for example, for hydrogen isolation from a steam reformer gas. The hydrogen-containing gas mixture to be fractionated contains 15% by volume CO₂, 5% by volume CH₄, 5% by volume CO, 3% by volume N₂ and 72% by volume CH₄. The impurities in the product gas are a max. 10 ppm CO.

1) Prior Art (2-Layer Bed Plus Upstream Dryer Bed)
ratio activated carbon/5 A molecular sieve in volume fractions: 0.54:0.46
adsorption pressure: 20 bar
purge gas pressure: 1.45 bar
raw gas temperature: 23° C.
normalized capacity: 1.00
normalized productivity: 1.00
hydrogen yield: 84.8%

2) Invention (3-Layer Bed Plus Upstream Dryer Bed)
ratio activated carbon/intermediate layer (NaX)/5 A molecular sieve in volume fractions: 0.37:0.16:0.47
adsorption pressure: 20 bar
purge gas pressure: 1.45 bar
raw gas temperature: 23° C.
normalized capacity: 1.041
normalized productivity: 1.014
hydrogen yield: 86.0%

The entire disclosures of all applications, patents and publications, cited herein and of corresponding German application No. DE 102006008194.3, filed Feb. 22, 2006, are incorporated by reference herein.

The preceding examples can be repeated with similar success by substituting the generically or specifically described reactants and/or operating conditions of this invention for those used in the preceding examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A method for fractionation of a hydrogen-containing gas mixture by adsorption, comprising:
passing the gas mixture over an adsorption bed containing an activated-carbon layer, a downstream molecular sieve layer of the 5 A type, and between said activated-carbon layer and said downstream molecular sieve layer, an intermediate layer containing a molecular sieve of the X type; and
removing a hydrogen-rich gas mixture from said adsorption bed.

2. A method according to claim 1, wherein said molecular sieve(s) of the X type is a CaX type, an NaX type, or a combination thereof.

3. A method according to claim 1, wherein the ratio of activated-carbon layer:intermediate layer:molecular sieve layer in volume fractions is 0.1 to 0.5:0.1 to 0.5:0.2 to 0.8, preferably 0.3:0.2:0.5.

4. A method according to claim 3, wherein the ratio of activated-carbon layer:intermediate layer:molecular sieve layer in volume fractions is 0.3:0.2:0.5.

5. A method according to claim 1, wherein said hydrogen-containing gas mixture contains water and water is removed from said hydrogen-containing gas mixture in an adsorbent layer upstream of said activated-carbon layer.

6. A device for fractionation by adsorption of a hydrogen-containing gas mixture, comprising:
an activated-carbon layer;
an intermediate layer containing a molecular sieve of the X type; and
a downstream molecular sieve layer of the 5 A type;
wherein said intermediate layer is positioned between said activated-carbon layer and said downstream molecular sieve layer of the 5 A type.

7. A device according to claim 6, wherein said molecular sieve(s) of the X type is a CaX type, an NaX type, or a combination thereof.

8. A device according to claim 6, wherein the ratio of activated-carbon layer:intermediate layer:molecular sieve layer in volume fractions is 0.1 to 0.5:0.1 to 0.5:0.2 to 0.8, preferably 0.3:0.2:0.5.

9. A device according to claim 8, wherein the ratio of activated-carbon layer:intermediate layer:molecular sieve layer in volume fractions is 0.3:0.2:0.5.

10. A device according to claim 6, wherein an adsorbent layer suitable for removing water is positioned upstream of said activated-carbon layer.

11. A method according to claim 1, wherein said intermediate layer consists of molecular sieve of the X type.

12. A device according to claim 6, wherein said intermediate layer consists of molecular sieve of the X type.

13. A device for fractionation by adsorption of a hydrogen-containing gas mixture, comprising:
an absorber having an inlet and an outlet and, positioned between said inlet and said outlet, an activated-carbon layer, an intermediate layer containing a molecular sieve of the X type, and a downstream molecular sieve layer of the 5 A type;
wherein said intermediate layer is positioned between said activated-carbon layer and said downstream molecular sieve layer of the 5 A type.

14. In a pressure-swing adsorption system comprising a plurality of adsorbers connected in series, the improvement wherein said plurality of adsorbers includes at least one adsorber according to claim 13.

15. A method for fractionation of a hydrogen-containing gas mixture by adsorption, comprising:
Introducing the gas mixture into a pressure-swing adsorption system according to claim 14; and
removing a hydrogen-rich gas mixture from said adsorption system.
